(19) United States
(12) Patent Application Publication
(10) Pub. No.: US 2025/0376594 A1
(43) Pub. Date: Dec. 11, 2025

(54) MELT-BLENDED THERMOPLASTIC PROTEIN ELASTOMER COMPOSITES

(71) Applicant: MODERN MEADOW, INC., Nutley, NJ (US)

(72) Inventors: Nicholas Andrew YARAGHI, Hoboken, NJ (US); Dale Lee HANDLIN, JR., Clifton, NJ (US); Shaobo CAI, Oradell, NJ (US); Bryce Michael KRIEGMAN, Jersey City, NJ (US); Gregory Matthew PITCH, Cedar Grove, NJ (US)

(21) Appl. No.: 18/874,307

(22) PCT Filed: Jun. 15, 2023
(86) PCT No.: PCT/US2023/068468

§ 371 Date: Dec. 12, 2024

Related U.S. Application Data
(60) Provisional application No. 63/352,902, filed on Jun. 16, 2022.

(51) Int. Cl. C08L 89/06; C08J 3/20; C08J 3/24; C08J 5/18; C08K 5/053; C08L 15/00

(52) U.S. Cl. CPC C08L 89/06; C08J 3/203; C08J 3/246; C08J 5/18; C08K 5/053; C08L 15/00; C08J 2315/00; C08J 2389/06; C08J 2415/00; C08J 2489/06; C08L 2203/16

(57) ABSTRACT

The present disclosure relates to thermoplastic protein elastomer compositions comprising protein, at least one reactive thermoplastic elastomer, and at least one softener, as well as composite materials made from these compositions. Methods of making and using the thermoplastic protein elastomer composite materials to produce engineered leather are also disclosed. In some embodiments, the protein is selected from the group consisting of: soy protein, cellulase, zein protein, egg white albumin, and pea protein; and wherein the protein and the thermoplastic elastomer are not covalently bound together. In some embodiments, the protein and the thermoplastic elastomer are present in co-continuous phases.

### FIELD

The present disclosure relates to thermoplastic protein elastomer composite materials comprising a protein blended with a thermoplastic elastomer. In some embodiments, the thermoplastic protein elastomer composite materials can be used to make a textile or fabric article, for example, a textile or fabric article typically prepared from natural leather.

### BACKGROUND

Leather is a versatile product used across many industries, including the furniture industry, where leather is regularly used as upholstery, the clothing industry, where leather is used to manufacture pants and jackets, the shoes industry, where leather is used to prepare casual and dress shoes, the luggage industry, the handbag and accessory industry, and the automotive industry. The global trade value for leather is high, and there is a continuing and increasing demand for leather products. Despite leathers seeming ubiquity, there are variety of costs, constraints, and social concerns associated with producing natural leather. Foremost, natural leathers are produced from animal skins, and as such, require raising and slaughtering livestock. Raising livestock requires enormous amounts of feed, pastureland, water, and fossil fuels, and contributes to air and waterway pollution through, for example, greenhouse gases like methane. Leather production also raises social concerns related to the treatment of animals. In recent years, there has also been a fairly well documented decrease in the availability of traditional high quality hides. For at least these reasons, alternative means to meet the demand for leather are desirable.

### SUMMARY

The present disclosure provides thermoplastic protein elastomer composite materials suitable for use in a variety of applications, including textile and fabric applications. In some embodiments, the thermoplastic protein elastomer composite material comprises a protein and a thermoplastic elastomer that are covalently bound together. In some embodiments, the protein and the thermoplastic elastomer are not covalently bound together. In some embodiments, the protein and the thermoplastic elastomer are present in co-continuous phases. The present disclosure also provides methods of making the thermoplastic protein elastomer composite and articles comprising the thermoplastic protein elastomer composite.

A first embodiment (1) of the present disclosure is directed to a thermoplastic protein elastomer composite material comprising a protein comprising at least one first reactive functional group that has been reacted with a thermoplastic elastomer comprising at least one second reactive functional group, wherein the protein is a protein other than collagen, gelatin, or any combination thereof.

In a second embodiment (2), the protein and the thermoplastic elastomer according to the first embodiment (1) are covalently bound together through reaction of the first and second reactive functional groups.

In a third embodiment (3), the protein according to first embodiment (1) or the second embodiment (2) is selected from the group consisting of: soy protein, cellulase, zein protein, egg white albumin, and pea protein.

In a fourth embodiment (4), the first reactive functional group according to any one of embodiments (1)-(3) is an amino group, a hydroxyl group, or a carboxylic acid group.

In a fifth embodiment (5), the second reactive functional group according to any one of embodiments (1)-(4) is a maleic anhydride, an epoxy group, a silane, or a glycidyl group.

In a sixth embodiment (6), the second reactive functional group according to the fifth embodiment (5) is an epoxy group.

In a seventh embodiment (7), the thermoplastic elastomer according to any one of embodiments (1)-(6) is selected from the group consisting of: a maleated polyethylene, a maleated polypropylene, a maleated styrene-ethylene-butene-styrene block copolymer, a maleated styrene-butadiene-styrene block copolymer, a maleated styrene-ethylene-propylene-styrene block copolymer, a maleated ethylene-propylene rubber, an epoxidized natural rubber, a methyl methacrylate grafted natural rubber, a polyhydroxyalkanoate, and a polyurethane.

In an eighth embodiment (8), the thermoplastic elastomer according to any one of embodiments (1)-(6) is an epoxidized natural rubber.

In a ninth embodiment (9), the epoxidized natural rubber according to embodiment (8) comprises about 50% epoxidized alkene bonds.

In a tenth embodiment (10), the composite material according to any one of embodiments (1)-(9) is a film.

An eleventh embodiment (11) of the present disclosure is directed to method of making a thermoplastic protein elastomer composite material, the method comprising: compounding, at a temperature from about 50° C. to about 180° C., a mixture comprising:
(a) a protein comprising a first functional group, wherein the protein is a protein other than collagen, gelatin, or any combination thereof;
(b) a reactive thermoplastic elastomer comprising a second functional group capable of reacting with the first functional group during compounding; and
(c) a softener.

In a twelfth embodiment (12), the protein according to the eleventh embodiment (11) is selected from the group consisting of, soy protein, cellulase, zein protein, egg white albumin, and pea protein.

In a thirteenth embodiment (13), the softener according to the eleventh embodiment (11) or the twelfth embodiment (12) is a protein softener.

In a fourteenth embodiment (14), the protein softener according to the thirteenth embodiment (13) is an alcohol.

In a fifteenth embodiment (15), the alcohol according to the fourteenth embodiment (14) is glycerol.

In a sixteenth embodiment (16), the method according to any one of embodiments (11)-(15) comprises mixing the protein and the softener to form a protein solution, and compounding the protein solution and the reactive thermoplastic elastomer to form the thermoplastic protein elastomer composite material.

In a seventeenth embodiment (17), the mixture according to any one of embodiments (11)-(16) further comprises a catalyst configured to facilitate the reaction between the second functional group and the first functional group during compounding.

In a eighteenth embodiment (18), the method according to any one of embodiments (11)-(17) further comprises hot pressing the thermoplastic protein elastomer composite to form a thermoplastic protein composite film.

In a nineteenth embodiment (19), the method according to any one of embodiments (11)-(18) further comprises attaching the thermoplastic protein composite to a fabric.

A twentieth embodiment (20) of the present disclosure is directed to an article comprising the composite material according to any one of embodiments (1)-(19).

A twenty-first embodiment (21) of the present disclosure is directed to a thermoplastic protein elastomer composite material comprising a protein blended with a thermoplastic elastomer, wherein the protein is present within the composite material in a first phase and the thermoplastic elastomer is present within the composite material in a second phase, and wherein the first phase and the second phase are co-continuous.

In a twenty-second embodiment (22), about 50% to about 99% of the protein according to the twenty-first embodiment (21) is covalently bound to the thermoplastic elastomer.

In a twenty-third embodiment (23), about 20% to less than about 50% of the protein according to the twenty-first embodiment (21) is covalently bound to the thermoplastic elastomer.

In a twenty-fourth embodiment (24), a detectable amount of the protein to less than about 20% of the protein according to the twenty-first embodiment (21) is covalently bound to the thermoplastic elastomer.

In a twenty-fifth embodiment (25), the protein according to the twenty-first embodiment (21) is not covalently bound to the thermoplastic elastomer.

In a twenty-sixth embodiment (26), the protein and the thermoplastic elastomer according to the twenty-first embodiment (21) are covalently bound together through reaction of a first functional group on the protein and a second reactive functional group on the thermoplastic elastomer.

In a twenty-seventh embodiment (27), the protein according to any one of embodiments (21)-(26) is a protein other than collagen, gelatin, or any combination thereof.

In a twenty-eighth embodiment (28), the protein according to any one of embodiments (21)-(26) is selected from the group consisting of: soy protein, cellulase, and zein protein.

In a twenty-ninth embodiment (29), the thermoplastic elastomer according to any one of embodiments (21)-(28) is selected from the group consisting of: a maleated polyethylene, a maleated polypropylene, a maleated styrene-ethylene-butene-styrene block copolymer, a maleated styrene-butadiene-styrene block copolymer, a maleated styrene-ethylene-propylene-styrene block copolymer, a maleated ethylene-propylene rubber, an epoxidized natural rubber, a methyl methacrylate grafted natural rubber, a polyhydroxyalkanoate, and a polyurethane.

In a thirtieth embodiment (30), the thermoplastic elastomer according to any one of embodiments (21)-(28) is an epoxidized natural rubber.

In a thirty-first embodiment (31), the epoxidized natural rubber according to the thirtieth embodiment (30) comprises about 50% epoxidized alkene bonds.

In a thirty-second embodiment (32), the composite material according to any one of embodiments (21)-(31) is a film.

In a thirty-third embodiment (33), at a temperature between about 50° C. to about 180° C., the first phase according to any one of embodiments (21)-(32) has a first complex viscosity at an angular frequency and the second phase according to any one of embodiments (21)-(32) has a second complex viscosity at the angular frequency, further wherein the first complex viscosity is no more than one order of magnitude greater than the second complex viscosity, and wherein the first complex viscosity is no more than one order of magnitude less than the second complex viscosity.

A thirty-fourth embodiment (34) of the present disclosure is directed to a method of making a thermoplastic protein elastomer composite material, the method comprising: compounding, at a temperature from about 50° C. to about 180° C., a mixture comprising:
(a) a protein;
(b) a thermoplastic elastomer; and
(c) a softener,
wherein, after compounding, the protein is present within the composite material in a first phase and the thermoplastic elastomer is present within the composite material in a second phase, and wherein the first phase and the second phase are co-continuous.

In a thirty-fifth embodiment (35), the protein according to the thirty-fourth embodiment (34) is a protein other than collagen, gelatin, or any combination thereof. In a thirty-sixth embodiment (36), the protein according to the thirty-fourth embodiment (34) is selected from the group consisting of: soy protein, cellulase, and zein protein.

In a thirty-seventh embodiment (37), the softener according to any one of embodiments (34)-(36) is an alcohol.

In a thirty-eighth embodiment (38), the alcohol according to the thirty-seventh embodiment (37) is glycerol.

In a thirty-ninth embodiment (39), the method according to any one of

embodiments (34)-(38) further comprises mixing the protein and the softener to form a protein solution, and compounding the protein solution and the thermoplastic elastomer to form the thermoplastic protein elastomer composite material.

In a fortieth embodiment (40), the method according to any one of embodiments (34)-(39) further comprises hot pressing the thermoplastic protein elastomer composite to form a thermoplastic protein composite film.

In a forty-first embodiment (41), the method according to any one of

embodiments (34)-(40) further comprises attaching the thermoplastic protein composite to a fabric.

In a forty-second embodiment (42), wherein at the temperature between about 50° C. to about 180° C., the first phase according to any one of embodiments (34)-(41) has a first complex viscosity at an angular frequency and the second phase according to any one of embodiments (34)-(41) has a second complex viscosity at the angular frequency, further wherein the first complex viscosity is no more than one order of magnitude greater than the second complex viscosity, and wherein the first complex viscosity is no more than one order of magnitude less than the second complex viscosity.

In a forty-third embodiment (43), after compounding, about 50% to about 99% of the protein according to any one of embodiments (34)-(42) is covalently bound to the thermoplastic elastomer.

In a forty-fourth embodiment (44), after compounding, about 20% to less than about 50% of the protein according to any one of embodiments (34)-(42) is covalently bound to the thermoplastic elastomer.

In a forty-fifth embodiment (45), after compounding, a detectable amount of the protein to less than about 20% of the protein according to any one of embodiments (34)-(42) is covalently bound to the thermoplastic elastomer.

In a forty-sixth embodiment (46), after compounding, the protein according to any one of embodiments (34)-(42) is not covalently bound to the thermoplastic elastomer.

In a forty-seventh embodiment (47), after compounding, the protein and the thermoplastic elastomer according to any one of embodiments (34)-(42) are covalently bound together through reaction of a first functional group on the protein and a second reactive functional group on the thermoplastic elastomer.

A forty-eighth embodiment (48) of the present disclosure is directed to an article comprising the composite material according to any one of embodiments (21)-(47).

In a forty-ninth embodiment (49), the percentage of the protein covalently bound to the thermoplastic elastomer according to any one of embodiments (22)-(24) is measured as a mol %.

In a fiftieth embodiment (50), the percentage of the protein covalently bound to the thermoplastic elastomer according to any one of embodiments (22)-(24) is measured as a wt %.

In a fifty-first embodiment (51), the percentage of the protein covalently bound to the thermoplastic elastomer according to any one of embodiments (43)-(45) is measured as a mol %.

In a fifty-second embodiment (52), the percentage of the protein covalently bound to the thermoplastic elastomer according to any one of embodiments (43)-(45) is measured as a wt %.

### BRIEF DESCRIPTION OF THE DRAWINGS

FIG. 1 is a graph of the complex viscosity for epoxidized natural rubber-50 and two protein solutions measured at 100° C.

FIG. 2 is a graph of the complex viscosity for epoxidized natural rubber-50 and two protein solutions measured at 120° C.

### DETAILED DESCRIPTION

### Definitions

As used herein, “a,” “an,” and “the” include the plural referents unless the context clearly dictates otherwise. The terms “a” or “an,” as well as the terms “one or more,” and “at least one” can be used interchangeably herein.

As used in the claims, “comprising” is an open-ended transitional phrase. A list of elements following the transitional phrase “comprising” is a non-exclusive list, such that elements in addition to those specifically recited in the list can also be present. As used in the claims, “consisting essentially of” or “composed essentially of” limits the composition of a material to the specified materials and those that do not materially affect the basic and novel characteristic(s) of the material. As used in the claims, “consisting of” or “composed entirely of” limits the composition of a material to the specified materials and excludes any material not specified.

Where a range of numerical values is recited herein, comprising upper and lower values, unless otherwise stated in specific circumstances, the range is intended to include the endpoints thereof, and all integers and fractions within the range. It is not intended that the scope of the claims be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to. Whether or not a numerical value or end-point of a range recites “about,” the numerical value or end-point of a range is intended to include two embodiments: one modified by “about,” and one not modified by “about.”

As used herein, the term “about” refers to a value that is within ±10% of the value stated. For example, about 3 kPa can include any number between 2.7 kPa and 3.3 kPa. That said, if a percentage is listed and the value of that percentage cannot go above 100%, for example 100 wt % or 99 wt %, “about” does not modify the percentage to include values over 100%.

As used herein, the term “substantially free of” means that a component is present in a detectable amount not exceeding about 0.1 wt %.

As used herein, the term “thermoplastic elastomer” refers to a polymer that (1) has the ability to be stretched beyond its original length and retract to substantially its original length when released; and (2) softens when exposed to heat and returns to substantially it original condition when cooled to room temperature. In some embodiments, the thermoplastic elastomers are not cross-linked and are otherwise void of cross-linking.

As used herein, the term “maleated” refers to a polymer in which one or more maleic anhydride groups have been grafted onto the polymer backbone.

As used herein, the term “epoxidized” refers to a polymer in which one or more double bonds in the polymer backbone have been converted into an epoxide.

As used herein, the term “softener” refers to a substance or material incorporated into another material (usually a plastic or elastomer) to increase its flexibility, workability, or flowability.

As used herein, a protein described as “covalently bound to” a thermoplastic elastomer means that the protein is directly bound to the thermoplastic elastomer by a covalent bond. For example, it is believed that hydroxyl and/or amino groups in proteins can react with anhydride, epoxide, or other reactive functional groups present on the thermoplastic elastomer to form a covalent bond linking the protein to the polymer. In some embodiments, the covalent bond can be formed using a cross-linking reagent. The nature of the linkage, i.e. the number of atoms separating the protein from the polymer's backbone and the nature of the covalent bond (i.e. carbon-oxygen, carbon-nitrogen, etc.), will vary depending on the placement and nature of the functional group(s) present on a given thermoplastic elastomer and on the specific cross-linking reagent, if a cross-linking reagent is used.

As used herein, the term “thermoplastic protein elastomer composite material” refers to the product formed after blending, heating, and cooling a thermoplastic protein elastomer composition. In some embodiments, the thermoplastic protein elastomer composite material refers to the product formed after a protein and a thermoplastic elastomer react.

As used herein, when discussing the two or more phases in a material, the term “co-continuous” is used to refer to two or more phases that are homogenously mixed within one another. In a co-continuous blend of two or more phases, neither the first phase nor the second phase is a dispersed phase fully enveloped by the other phase. Rather, in a co-continuous blend, the two or more phases are similar in morphology and are interpenetrating. Typically, the two or more phases are elongated interpenetrating phases.

The present disclosure provides thermoplastic protein elastomer compositions, thermoplastic protein elastomer composite materials, and methods of making thermoplastic protein elastomer composite materials that have a look and feel, as well as mechanical properties, similar to natural leather. The thermoplastic protein elastomer composite materials can have, among other things, haptic properties, aesthetic properties, mechanical/performance properties, manufacturability properties, and/or thermal properties similar to natural leather.

Mechanical/performance properties that can be similar to natural leather include, but are not limited to, tensile strength, tear strength, elongation at break, resistance to abrasion, internal cohesion, water resistance, and the ability to retain color when rubbed (color fastness). Haptic properties that can be similar to natural leather include, but are not limited to, softness, rigidity, coefficient of friction, and compression modulus. Aesthetic properties that can be similar to natural leather include, but are not limited to, dye-ability, embossing, aging, color, color depth, and color patterns. Manufacturing properties that can be similar to natural leather include, but are not limited to, the ability to be stitched, cut, skived, and split. Thermal properties that can be similar to natural leather include, but are not limited to, heat resistance and resistance to stiffening or softening over a significantly wide temperature range, for example 25° C. to 100° C.

### Thermoplastic Protein Elastomer Compositions

The present disclosure provides thermoplastic protein elastomer compositions. These compositions are suitable for preparing thermoplastic protein elastomer composite materials after treatment under suitable conditions described elsewhere herein. For example, and in some embodiments, subjecting a thermoplastic protein elastomer composition to heat provides a thermoplastic protein elastomer composite material.

In one embodiment, the present disclosure provides a thermoplastic protein elastomer composition comprising:
(a) a protein;
(b) a reactive thermoplastic elastomer; and
(c) a softener.

In some embodiments, the thermoplastic protein elastomer composition further comprises at least one unreactive thermoplastic elastomer.

### Protein

In some embodiments, the protein can be a soy protein. In some embodiments, the protein can be soy protein isolate. In some embodiments, the protein can be a collagen. In some embodiments, the protein can be gelatin. In some embodiments, the protein can be pea protein. In some embodiments, the protein can be egg white albumin. In some embodiments, the protein can be zein protein. In some embodiments, the protein can be an enzyme. In some embodiments, the protein can be cellulase.

Although many types of proteins are contemplated for use in the composite materials described herein including, for example, collagen and gelatin, it is understood that for all of the embodiments disclosed herein, the protein can be a protein other than collagen and/or gelatin. Thus, in some embodiments, the protein can be a protein other than collagen, gelatin, or any combination thereof. In some embodiments, the composite material can be free of or substantially free of collagen. In some embodiments, the composite material can be free of or substantially free of gelatin. In some embodiments, the composite material can be free of or substantially free of collagen and gelatin.

In some embodiments, the molecular weight of the protein can be about 10 kDa to about 1000 kDa. In some embodiments, the molecular weight of the protein can be about 10 kDa to about 1000 kDa, about 10 kDa to about 500 kDa, about 10 kDa to about 400 kDa, about 10 kDa to about 300 kDa, about 10 kDa to about 200 kDa, about 10 kDa to about 100 kDa, about 10 kDa to about 50 kDa, about 50 kDa to about 1000 kDa, about 50 kDa to about 500 kDa, about 50 kDa to about 400 kDa, about 50 kDa to about 300 kDa, about 50 kDa to about 200 kDa, about 50 kDa to about 100 kDa, about 100 kDa to about 1000 kDa, about 100 kDa to about 500 kDa, about 100 kDa to about 400 kDa, about 100 kDa to about 300 kDa, about 100 kDa to about 200 kDa, about 200 kDa to about 1000 kDa, about 200 kDa to about 500 kDa, about 200 kDa to about 400 kDa, about 200 kDa to about 300 kDa, about 300 kDa to about 1000 kDa, about 300 kDa to about 500 kDa, about 300 kDa to about 400 kDa, about 400 kDa to about 1000 kDa, about 400 kDa to about 500 kDa, or about 500 kDa to about 1000 kDa.

In some embodiments, the protein can be dissolved in aqueous solution to form a protein solution. In some embodiments, the protein solution further can comprise one or more protein softeners. In some embodiments, the protein softener is glycerol. When blended with a thermoplastic elastomer as discussed herein, the protein solution may be referred to as a protein phase and the thermoplastic elastomer may be referred to a polymer phase.

### Thermoplastic Elastomer

The compositions described herein comprise at least one thermoplastic elastomer. In some embodiments, the composition can comprise one to five, one to four, one to three, one to two, two to five, two to four, two to three, three to five, three to four, or four to five thermoplastic elastomers. In some embodiments, the composition can comprise one, two, three, four, or five thermoplastic elastomers. In some embodiments, the composition can comprise one thermoplastic elastomer. In some embodiments, the composition can comprise two thermoplastic elastomers.

Thermoplastic elastomers are a class of copolymers that consist of materials with both thermoplastic and elastomeric properties. There are six main classes of thermoplastic elastomers: (1) styrenic block copolymers; (2) thermoplastic polyolefin elastomers; (3) thermoplastic vulcanizates; (4) thermoplastic polyurethanes; (5) thermoplastic copolyester; and (6) thermoplastic polyamides. Thermoplastic elastomer compositions are versatile because they exhibit beneficial elastomeric properties and can be processed using standard thermoplastic processing equipment. In order to qualify as a thermoplastic elastomer, a material must possess the following characteristics: (1) the ability to be stretched to moderate elongation and, upon the removal of stress, return to something close to its original shape; (2) processable as a melt at elevated temperature; and (3) absence of significant creep.

Due to a wide difference in polarity between proteins and nonpolar thermoplastic elastomers, proteins typically do not disperse easily in the nonpolar thermoplastic elastomers and instead tend to agglomerate during mixing due to the tendency to form strong intermolecular hydrogen bonds with other protein molecules. Because of the poor compatibility and dispersability of proteins with nonpolar thermoplastic elastomers, it is difficult to obtain composite materials wherein the protein and thermoplastic elastomer form a single phase or co-continuous phases. It has been surprisingly discovered, however, that the compatibility of proteins with thermoplastic elastomers is improved when the thermoplastic elastomers comprise polar reactive groups such as anhydrides and epoxides. Mixing proteins with thermoplastic elastomers comprising these functional groups can result in composites forming a single phase or co-continuous protein and polymer phases.

In some embodiments, a thermoplastic elastomer comprising polar reactive groups may be chemically reactive with proteins under normal processing conditions. Without wishing to be bound by a particular theory, it is believed that hydroxyl and/or amino groups in proteins may react with anhydride groups, epoxide groups, or other reactive functional groups present in the thermoplastic elastomer comprising polar reactive groups such that the protein is covalently bound to the thermoplastic elastomer. Because proteins contain multiple hydroxyl and/or amino groups that can react with multiple functional groups present in the thermoplastic elastomer, the functional groups in proteins can react with functional groups present on one or more polymeric chains in the thermoplastic elastomers. That is, and in certain embodiments, proteins can behave as cross-linking agents. Furthermore, and again without wishing to be bound by any particular theory, it is believed that the anhydride groups, epoxide groups, or other reactive functional groups present in the thermoplastic elastomer may facilitate non-covalent interactions with the protein, such as hydrogen bonding, Van der Waals interactions, dipole-dipole forces, and polarization forces, that reduce the interfacial tension between the protein phase and the polymer phase, making the formation of co-continuous protein and polymer phases more feasible. It is believed that the formation of covalent bonds between the protein and the thermoplastic elastomer, the formation of non-covalent interactions between the protein and the thermoplastic elastomer, or a combination thereof can be responsible for the formation of a single phase and/or the formation of co-continuous protein and polymer phases.

Without wishing to be bound by theory, it is believed that, if a blended protein phase and polymer phase have similar complex viscosities (e.g., complex viscosities within one order of magnitude of each other) at a blending temperature and shear rate, they are more likely to form a co-continuous phase morphology. In addition, it is believed higher Tan (delta) and lower complex viscosity values for each of the protein phase and the polymer phase generally facilitate sufficient flow and mixing within a compounder used to blend the protein phase and polymer phase. It is also believed that if the protein phase and polymer phase have similar volume fractions (e.g., 50:50 v/v), they are more likely to form a co-continuous phase morphology. Furthermore, it is believed that if the protein phase and polymer phase have both i) similar complex viscosities at the blending temperature and shear rate and ii) similar volume fractions, they are more likely to form a co-continuous phase morphology.

In some embodiments, the volume fraction of the protein phase relative to the polymer phase can be about 50:50. In some embodiments, the volume fraction of the protein phase relative to the polymer phase can be about 25:75, about 30:70, about 35:65, about 40:60, about 45:55, about 55:45, about 60:40, about 65:35, about 70:30, or about 25:75.

The complex viscosity of the protein phase and the polymer phase can be

measured using a rheometer, as described herein. In some embodiments, at a temperature between about 50° C. to about 180° C., the protein phase and the polymer phase can have complex viscosities that are substantially similar at a certain angular frequency. In some embodiments, at a temperature between about 50° C. to about 180° C., the protein phase and the polymer phase can have complex viscosities that are different by no more than one order of magnitude at a certain angular frequency.

In some embodiments, at a temperature between about 50° C. to about 180° C., the protein phase can have a first complex viscosity a certain angular frequency and the polymer phase can have a second complex viscosity at the angular frequency. In some embodiments, the first complex viscosity is no more than one order of magnitude greater than the second complex viscosity and the first complex viscosity is no more than one order of magnitude less than the second complex viscosity. In some embodiments, the first complex viscosity is no more than one-half an order of magnitude greater than the second complex viscosity and the first complex viscosity is no more than one-half an order of magnitude less than the second complex viscosity. In some embodiments, the first complex viscosity is no more than three-fourths an order of magnitude greater than the second complex viscosity and the first complex viscosity is no more than three-fourths an order of magnitude less than the second complex viscosity. In some embodiments, the temperature between about 50° C. to about 180° C. can be the temperature at which the protein phase and the polymer phase are blended to form a composite material.

Unless specified otherwise, the complex viscosity (measured in centipoise, cP) of a protein phase and a polymer phase are measured on non-compounded samples using the following procedure. Complex viscosity measurements are conducted on a TA Discovery HR-2 Rheometer (or equivalent equipment) using a parallel plate fixture. Complex viscosity is measured using a frequency sweep at certain temperature (e.g., 125° C. or 140° C.) or at certain frequency with a temperature ramp (e.g., 25° C. to 150° C.). Frequency sweeps at a certain temperature are used to observe the complex viscosity and Tan (delta) of the protein and polymer phases. Before testing a sample, the sample is dried in an oven at 45° C. for 6 to 12 hours. Immediately after drying, the samples are conditioned and tested. Samples tested using a frequency sweep are conditioned at their testing temperature for about 3 minutes to about 10 minutes, held under modest compression conditions (0.2±0.1N), and oscillated from 0.1 rad/s to 100 rad/s at a strain previously determined to be within the linear viscoelastic range, typically 0.1% to 1%. The linear viscoelastic range is determined using an amplitude sweep procedure, in which a sweep from 0.01% strain to 100% strain at 10 rad/s is performed, which reveals the strain at which a material begins to yield. A strain that is within the linear viscoelastic region is then chosen for use in the frequency sweep. For samples tested using a temperature ramp, the samples are conditioned at the starting temperature of the temperature ramp for about 3 minutes to about 10 minutes, held under modest compression conditions (0.2±0.1N), and oscillated at a single frequency at a strain previously determined to be within the linear viscoelastic range, typically 0.1% to 1.

In some embodiments, the thermoplastic elastomer can be a maleated thermoplastic elastomer. In some embodiments, the maleated thermoplastic elastomer can be a maleated polyethylene, a maleated polypropylene, a maleated styrenic block copolymer such as maleated styrene-ethylene-butene-styrene block copolymer, maleated styrene-butadiene-styrene block copolymer, or maleated styrene-ethylene-propylene-styrene block copolymer, a maleated ethylene-propylene rubber, a polyhydroxyalkanoate, or a polyurethane.

In some embodiments, the thermoplastic elastomer can be a natural rubber. In some embodiments, the thermoplastic elastomer can be a modified natural rubber. In some embodiments, the modified natural rubber can be an epoxidized natural rubber or a methyl methacrylate grafted natural rubber.

In some embodiments, the thermoplastic elastomer can be polystyrene-block-poly(ethylene-ran-butylene)-block-polystyrene-graft maleic anhydride, polyisoprene-graft-maleic anhydride, poly(propylene-graft-maleic anhydride), maleic anhydride-grafted-ethylene-propylene rubber, poly(ethylene-co-methyl acrylate-co-glycidyl methacrylate), polyethylene-graft-maleic anhydride, or epoxidized natural rubber.

In some embodiments, the composition can comprise by weight of the protein about 10% to about 1000% of the at least one thermoplastic elastomer. In some embodiments, the composition can comprise by weight of the protein about 10% to about 1000%, about 10% to about 500%, about 10% to about 200%, about 10% to about 100%, about 10% to about 75%, about 10% to about 50%, about 50% to about 1000%, about 50% to about 500%, about 50% to about 200%, about 50% to about 100%, about 50% to about 75%, about 75% to about 1000%, about 75% to about 500%, about 75% to about 200%, about 75% to about 100%, about 100% to about 1000%, about 100% to about 500%, about 100% to about 200%, about 200% to about 1000%, about 200% to about 500%, or about 500% to about 1000% of the at least one thermoplastic elastomer. In some embodiments, the composition can comprise by weight of the protein about 75% to about 1000% of the at least one thermoplastic elastomer.

### Softener

Softeners can be incorporated into another material (usually a plastic or elastomer) to increase its flexibility, workability, or flowability. In some embodiments, a softener can be incorporated into a protein to increase its flexibility, workability, or flowability. In some embodiments, a softener can be incorporated into a thermoplastic elastomer to increase its flexibility, workability, or flowability. In some embodiments, a softener can be incorporated into both a protein and a thermoplastic elastomer. In some embodiments, the softener incorporated into a protein is the same as the softener incorporated into the thermoplastic elastomer. In some embodiments, the softener incorporated into a protein is different from the softener incorporated into the thermoplastic elastomer. A change in the type and level of a softener can affect the properties of the final flexible product. The selection for a specific polymer or elastomer is normally based on the compatibility between components; the amount required for plasticization; processing characteristics; desired thermal, electrical, and mechanical properties of the end product; permanence; resistance to water, chemicals, and solar radiation; toxicity; and cost.

In some embodiments, the composition can comprise at least one softener. In some embodiments, the composition can comprise one to five, one to four, one to three, one to two, two to five, two to four, two to three, three to five, three to four, or four to five softeners. In some embodiments, the composition can comprise one, two, three, four, or five softeners. In some embodiments, the composition can comprise one softener. In some embodiments, the composition can comprise two softeners.

In some embodiments, the softener can be a protein softener, discussed in detail below. In some embodiments, the softener can be an elastomer softener, also described in detail below.

In some embodiments, the composition can comprise at least one protein softener. In some embodiments, the composition can comprise at least one elastomer softener. In some embodiments, the compositions can comprise at least one protein softener and at least one elastomer softener.

### Protein Softener

In some embodiments, the composition can comprise at least one protein softener. In some embodiments, the composition comprises one to five, one to four, one to three, one to two, two to five, two to four, two to three, three to five, three to four, or four to five protein softeners. In some embodiments, the composition can comprise one, two, three, four, or five protein softeners. In some embodiments, the composition can comprise one protein softener.

In some embodiments, the protein softener can be water or an alcohol.

In some embodiments, the protein softener can be an alcohol. In some embodiments, the protein softener can be a glycol such as glycerol, ethylene glycol, diethylene glycol, triethylene glycol, tetraethylene glycol, polyethylene glycol, sorbitol, mannitol, xylitol, 1,4-butanediol, meso-erythritol, or adonitol. In some embodiments, the protein softener is glycerol.

In some embodiments, the protein softener can be polyethylene glycol (PEG) with a molecular weight (Mw) ranging from about 300 to about 20,000. In some embodiments, the protein softener can be a PEG with a molecular weight (Mw) of 300, 400, 600, 800, 1500, 4000, 10,000, or 20,000. In some embodiments, the protein softener can be PEG 300 or PEG 400.

In some embodiments, the composition can comprise by weight of the protein about 1% to about 200% of at least one protein softener. In some embodiments, the composition can comprise by weight of the protein about 1% to about 200%, about 1% to about 150%, about 1% to about 100%, about 1% to about 80%, about 1% to about 60%, about 1% to about 40%, about 1% to about 20%, about 1% to about 10%, about 10% to about 100%, about 10% to about 80%, about 10% to about 60%, about 10% to about 40%, about 10% to about 20%, about 20% to about 100%, about 20% to about 80%, about 20% to about 60%, about 20% to about 40%, about 40% to about 100%, about 40% to about 80%, about 40% to about 60%, about 60% to about 100%, about 60% to about 80%, about 80% to about 100%, about 100% to about 120%, about 100% to about 140%, about 100% to about 160%, about 100% to about 180%, about 100% to about 200%, about 120% to about 180%, or about 140% to about 160% of at least one protein softener. In some embodiments, the composition can comprise by weight of the protein about 80% to about 100% of at least one protein softener.

### Elastomer Softener

In some embodiments, the composition can comprise at least one elastomer softener. In some embodiments, the composition can comprise one to five, one to four, one to three, one to two, two to five, two to four, two to three, three to five, three to four, or four to five elastomer softeners. In some embodiments, the composition can comprise one, two, three, four, or five elastomer softeners. In some embodiments, the composition can comprise one elastomer softener.

In some embodiments, the elastomer softener can be a mineral oil, a processing oil, or a vegetable oil.

In some embodiments, the elastomer softener can be a processing oil. In some embodiments, the processing oil can be a paraffinic oil, a napthenic oil, an aromatic oil, or a natural oil. In some embodiments, the elastomer softener can be a paraffinic hydrocarbon oil. In some embodiments, the elastomer softener can be a paraffinic hydrocarbon oil having a molecular weight from about 200 to about 1,000.

In some embodiments, the elastomer softener can be a mineral oil.

In some embodiments, the elastomer softener can be a vegetable oil. In some embodiments, the vegetable oil can be a soybean oil, a linseed oil, a castor oil, a sunflower oil, a rubber seed oil, a palm oil, or a coconut oil.

In some embodiments, the composition can comprise by weight of the protein about 0.1% to about 200% of at least one elastomer softener. In some embodiments, the composition comprises by weight of the protein about 0.1% to about 200%, about 0.1% to about 100%, about 0.1% to about 60%, about 0.1% to about 40%, about 0.1% to about 20%, about 0.1% to about 10%, about 10% to about 200%, about 10% to about 100%, about 10% to about 60%, about 10% to about 40%, about 10% to about 20%, about 20% to about 200%, about 20% to about 100%, about 20% to about 60%, about 20% to about 40%, about 40% to about 200%, about 40% to about 100%, about 40% to about 60%, about 60% to about 200%, about 60% to about 100%, or about 100% to about 200% of at least one elastomer softener. In some embodiments, the composition can comprise by weight of the protein about 80% to about 100% of the at least one elastomer softener.

### Thermoplastic Protein Elastomer Composite Materials

The present disclosure provides a thermoplastic protein elastomer composite material. In some embodiments, the thermoplastic protein elastomer composite material comprises a protein covalently bound to a thermoplastic elastomer through at least one of an amide, ester, or amino bond. In some embodiments, the thermoplastic protein elastomer composite comprises a protein blended with a thermoplastic elastomer, wherein the protein is present within the composite material in a first phase and the thermoplastic elastomer is present within the composite material in a second phase, and wherein the first phase and the second phase are co-continuous. In some embodiments, the thermoplastic protein elastomer composite material comprises a combination of (i) protein covalently bound to a thermoplastic elastomer through at least one of an amide, ester, or amino bond, and (ii) protein present within the composite material in a first phase that is co-continuous with the thermoplastic elastomer present in a second phase, wherein the protein covalently bound to the thermoplastic elastomer is present in the first phase, in the second phase, at the interface between the first phase and the second phase, or a combination thereof. In some embodiments, the protein is a protein other than collagen, gelatin, or any combination thereof.

The present disclosure provides a thermoplastic protein elastomer composite material comprising a protein comprising at least one first reactive functional group that has been reacted with a thermoplastic elastomer comprising at least one second reactive functional group, wherein the protein is a protein other than collagen, gelatin, or any combination thereof. In some embodiments, the present disclosure provides a thermoplastic elastomer composite material comprising a protein comprising at least one first reactive functional group and at least one thermoplastic elastomer comprising at least one second reactive functional group, wherein the protein and the at least one thermoplastic elastomer are covalently bound together through reaction of the first and second reactive functional groups.

In some embodiments, the protein can be selected from the group consisting of soy protein, cellulase, zein protein, egg white albumin, and pea protein. In some embodiments, the protein can be selected from the group consisting of soy protein, cellulase, and zein protein. In some embodiments, the soy protein can be soy protein isolate.

In some embodiments, the first reactive functional group can be an amino group, a hydroxyl group, or a carboxylic acid group. In some embodiments, the second reactive functional group can be a maleic anhydride, an epoxy, a silane, or a glycidyl group. In some embodiments, the second reactive functional group is an epoxy group.

In some embodiments, the thermoplastic elastomer can have randomly located functional groups. In some embodiments, the thermoplastic elastomer with randomly located functional groups can be a randomly maleated polymer, a randomly epoxidized polymer, a randomly silanated polymer, or a randomly glycidated polymer.

In some embodiments, the thermoplastic elastomer with randomly located functional groups can be a randomly maleated polymer. In some embodiments, the randomly maleated polymer can be a randomly maleated polyethylene, a randomly maleated propylene, a randomly maleated ethylene-propylene copolymer (randomly maleated EPR or randomly maleated ethylene-polypropylene rubber), a randomly maleated ethylene-propylene-diene monomer terpolymer (randomly maleated EPDM), a randomly maleated block copolymer such as a styrenic block copolymer, or an acrylic block copolymer. In some embodiments, the randomly maleated polymer is randomly maleated EPR, randomly maleated EPDM, or a randomly maleated styrenic block copolymers such as randomly maleated poly(styrene-block-hydrogenated butadiene-block-styrene) (SEBS) or maleated poly(styrene-block-hydrogenated isoprene-styrene) (SEPS).

In some embodiments, the thermoplastic elastomer with randomly located functional groups can be a randomly epoxidized polymer. In some embodiments, the randomly epoxidized polymer can be a randomly epoxidized diene containing polymer. In some embodiments, the randomly epoxidized polymer can be a polymer containing isoprene monomer units such as randomly epoxidized natural rubber (ENR), a randomly epoxidized isoprene containing block copolymer such as poly(styrene-block-isoprene) or poly(stryrene-block isoprene-blockstyrene), a randomly epoxidized ethylene-propylene-diene monomer (epoxidized EPDM), or randomly epoxidized polyisobutylene.

In some embodiments, the epoxidized natural rubber comprises about 10%, about 20%, about 30%, about 40%, about 50%, about 60%, about 70%, about 80%, or about 90% epoxidized alkene bonds. In some embodiments, the epoxidized natural rubber comprises about 50% epoxidized alkene bonds. In some embodiments, the epoxidized natural rubber comprises from about 40% to about 60% epoxidized alkene bonds. In some embodiments, the epoxidized natural rubber comprises from about 10% to about 30%, from about 10% to about 50%, from about 10% to about 70%, from about 10% to about 90%, from about 20% to about 40%, from about 20% to about 60%, from about 20% to about 80%, from about 40% to about 80%, from about 50% to about 70%, from about 50% to about 90%, from about 60% to about 80%, or from about 70% to about 90% epoxidized alkene bonds.

In some embodiments, the randomly epoxidized polymer can present its epoxide groups through one or more randomly located glycidyl groups, i.e.

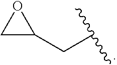 [SMILES: *CC1CO1]

In some embodiments, the thermoplastic elastomer with randomly located glycidyl groups can be a copolymer of glycidyl methacrylate or a polymer grafted with glycidyl methacrylate.

In some embodiments, the thermoplastic elastomer with randomly located functional groups can be a randomly silanated polymer. In some embodiments, the randomly silanated polymer can be a randomly silane-functionalized ethylene-propylene-diene monomer (silane-functionalized EPDM), a randomly silanated cellulosic polymer, a randomly silanated polyvinyl alcohol or a partially hydrolyzed polyvinyl acetate, a randomly silane-functionalized polydimethyl siloxane, or a randomly silanated adhesive polymer.

In some embodiments, the thermoplastic elastomer can have groups placed in blocks, as coupling agents, or on the ends. Examples of such polymers include, but are not limited to, block copolymers containing a glycidyl methacrylate block. Polymers coupled with silane coupling agents where functionality is still remaining on the silane coupling agents include styrene-butadiene rubbers and styreninc block copolymers.

In some embodiments, about 50 mol % to about 99 mol % of the protein is covalently bound to the thermoplastic elastomer. In some embodiments, about 60 mol % to about 99 mol %, about 70 mol % to about 99 mol %, about 80 mol % to about 99 mol %, about 90 mol % to about 99 mol %, about 60 mol % to about 90 mol %, about 70 mol % to about 90 mol %, about 80 mol % to about 90 mol %, about 60 mol % to about 80 mol %, about 70 mol % to about 80 mol %, or about 60 mol % to about 80 mol % of the protein is covalently bound to the thermoplastic elastomer.

In some embodiments, about 50 wt % to about 99 wt % of the protein is covalently bound to the thermoplastic elastomer. In some embodiments, about 60 wt % to about 99wt %, about 70 wt % to about 99 wt %, about 80 wt % to about 99 wt %, about 90 wt % to about 99 wt %, about 60 wt % to about 90 wt %, about 70 wt % to about 90 wt %, about 80 wt % to about 90 wt %, about 60 wt % to about 80 wt %, about 70 wt % to about 80 wt %, or about 60 wt % to about 80 wt % of the protein is covalently bound to the thermoplastic elastomer.

In some embodiments, about 20 mol % to less than about 50 mol % of the protein is covalently bound to the thermoplastic elastomer. In some embodiments, about 30 mol % to less than about 50 mol %, about 40 mol % to less than about 50 mol %, about 20 mol % to about 40 mol %, about 30 mol % to about 40 mol %, or about 20 mol % to about 30 mol % of the protein is covalently bound to the thermoplastic elastomer.

In some embodiments, about 20 wt % to less than about 50 wt % of the protein is covalently bound to the thermoplastic elastomer. In some embodiments, about 30 wt % to less than about 50 wt %, about 40 wt % to less than about 50 wt %, about 20 wt % to about 40 wt %, about 30 wt % to about 40 wt %, or about 20 wt % to about 30 wt % of the protein is covalently bound to the thermoplastic elastomer.

In some embodiments, a detectable amount of the protein to less than about 20mol % of the protein is covalently bound to the thermoplastic elastomer. In some embodiments, a detectable amount of the protein to less than about 10 mol % of the protein is covalently bound to the thermoplastic elastomer.

In some embodiments, a detectable amount of the protein to less than about 20wt % of the protein is covalently bound to the thermoplastic elastomer. In some embodiments, a detectable amount of the protein to less than about 10 wt % of the protein is covalently bound to the thermoplastic elastomer.

In some embodiments, the protein is not covalently bound to the thermoplastic elastomer.

In some embodiments, the thermoplastic protein elastomer composite material described herein can be subjected to the same, or similar finishing treatments as those used to treat natural leather. The treatment process for natural leather typically has three steps: preparation of the hide, tanning, retanning, fat-liquoring, and finishing. Tanning can be performed in any number of well-understood ways, including by contacting the thermoplastic protein elastomer composite material with a vegetable tanning agent, blocked isocyanate compounds, chromium compound, aldehyde, syntan, natural resin, tanning natural oil, or modified oil. Blocked isocyanate compounds can include X-tan. Vegetable tannins can include pyrogallol- or pyrocatechin-based tannins, such as valonea, mimosa, ten, tara, oak, pinewood, sumach, quebracho, and chestnut tannins. Chromium tanning agents can include chromium salts such as chromium sulfate. Aldehyde tanning agents can include glutaraldehyde and oxazolidine compounds. Syntans can include aromatic polymers, polyacrylates, polymethacrylates, copolymers of maleic anhydride and styrene, condensation products of formaldehyde with melamine or dicyandiamide, lignins, and natural flours.

To tan a composite material, the material's pH can be adjusted, for example lowered to a pH in the range of about 2.5 to about 3.0 in the presence of 10% salts (for example sodium chloride, sodium sulfate, or sodium salts), to allow for penetration of the tanning agent. Following penetration, the pH of the composite material can be adjusted again, for example raised to a pH in the range of about 3.5 to about 4.0, to fix the tanning agent. In some embodiments, a composite material can be soaked in a bath including 2 wt. % (based on the weight of protein infused into the composite material) of chromium (III) sulfate and the pH can be adjusted as necessary for penetration and fixation. For example, for a 10 gram composite material with 10% mass of protein, 0.02 gram of chrome chromium (III) sulfate powder can be dissolved in enough water to cover the composite material in a container (the amount of water will depend on container dimensions). The composite material can then be added to the container and the container can be agitated, for example on an orbital shaker at 50 rpm. The agitation can be performed at a pH of about 2.8 to about 3.2 and for a time sufficient to allow penetration of the chromium (III) sulfate into the composite material. After penetration, the pH of the bath can be increased and fixation of the chromium (III) sulfate can be performed at a pH between about 3.8 and about 4.2. The duration of the fixation step can be selected to achieve a desired color for the composite material.

In some embodiments, after tanning, the thermoplastic protein elastomer composite material can be retanned. Retanning refers to post-tanning treatments. Such treatments can include tanning a second time, wetting, sammying, dehydrating, neutralization, adding a coloring agent such as a dye, fat liquoring, fixation of unbound chemicals, setting, conditioning, softening, and/or buffing.

In some embodiments, a coloring agent can be incorporated into a thermoplastic protein elastomer composite material. In some embodiments, the coloring agent can be incorporated into the protein before mixing with a thermoplastic elastomer. In some embodiments, the coloring agent reacts with the protein before the protein reacts with the reactive thermoplastic elastomer.

In some embodiments, the coloring agent can be a dye. In some embodiments, the dye can include one or more chromophores that contain pendant reactive groups capable of forming covalent bonds. These dyes can achieve high wash fastness and a wide range of brilliant shades. Exemplary dyes, include but are not limited to, sulphatoethylsulphone (Remazol), vinylsulphone, and acrylamido dyes. In some embodiments, the dye can be an anionic dye. Exemplary anionic dyes include, but are not limited to, azo, stilbene, phthalocyanine, and dioxazine.

In some embodiments, about 0.01 wt. % to about 7.5 wt. % dye, based on protein weight, can be used. In some embodiments, the weight percent of dye, based on protein weight, can be about 0.01 wt. % to about 7.5 wt. %, about 0.01 wt. % to about 5 wt. %, about 0.01 wt. % to about 3 wt. %, about 0.01 wt. % to about 1 wt. %, about 0.01 wt. % to about 0.5 wt. %, about 0.01 wt. % to about 0.1 wt. %, about 0.1 wt. % to about 7.5 wt. %, about 0.1 wt. % to about 5 wt. %, about 0.1 wt. % to about 3 wt. %, about 0.1 wt. % to about 1 wt. %, about 0.1 wt. % to about 0.5 wt. %, about 0.5 wt. % to about 7.5 wt. %, about 0.5 wt. % to about 5 wt. %, about 0.5 wt. % to about 3 wt. %, about 0.5 wt. % to about 1 wt. %, about 1 wt. % to about 7.5 wt. %, about 1 wt. % to about 5 wt. %, about 1 wt. % to about 3 wt. %, about 3 wt. % to about 7.5 wt. %, about 3 wt. % to about 5 wt. %, or about 5 wt. % to about 7.5 wt. %.

In some embodiments, lubricants used during fat liquoring include fats, biological, mineral or synthetic oils, cod oil, sulfonated oil, polymers, organofunctional siloxanes, or other hydrophobic compounds or agents used for fat liquoring conventional leather, or mixtures thereof. Other lubricants can include surfactants, anionic surfactants, cationic surfactants, cationic polymeric surfactants, anionic polymeric surfactants, amphiphilic polymers, fatty acids, modified fatty acids, nonionic hydrophilic polymers, nonionic hydrophobic polymers, poly acrylic acids, poly methacrylic, acrylics, natural rubbers, synthetic rubbers, resins, amphiphilic anionic polymer and copolymers, amphiphilic cationic polymer and copolymers and mixtures thereof as well as emulsions or suspensions of these in water, alcohol, ketones, and other solvents. Lubricants can be incorporated in any amount that confers leather-like properties such as flexibility, decrease in brittleness, durability, or water resistance. In some embodiments, the amount of lubricant applied to a thermoplastic protein elastomer composite material can be in the range of about 0.1 wt. % to about 60 wt. % of the thermoplastic protein elastomer composite material. For example, the amount of lubricant applied can be about 0.1 wt. %, about 1 wt. %, about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, or about 60 wt. %, or within a range having any two of these values as endpoints, inclusive of the endpoints.

In some embodiments, during dehydration, water can be removed by filtration, evaporation, freeze-drying, solvent exchange, vacuum-drying, convection-drying, heating, irradiating or microwaving, or by other known methods for removing water.

A tanned thermoplastic protein elastomer composite material can be mechanically or chemically finished. For example, mechanical finishing can include polishing the composite material to yield a shiny surface; ironing and plating the composite material to achieve a flat, smooth surface; embossing the composite material to create a three-dimensional print or pattern on the material's surface; or tumbling the composite material to provide a more evident grain and smooth surface. Chemical finishing can involve the application of a film, a natural or synthetic coating, or other treatment. Chemical treatments can be applied, for example, by spraying, curtain coating, roller coating, or reverse transfer coating.

### Methods of Making a Thermoplastic Elastomer Composite Material

The majority of plastic products are prepared by so-called “hot compounding” techniques, where the ingredients in the composition are combined under heat and shearing forces that bring about a state of molten plastic (fluxing) which is shaped into the desired product, cooled, and allowed to develop ultimate properties of strength and integrity. Hot compounding methods include, but are not limited to, calendering, extrusion, injection, and compression molding.

The present disclosure provides a method of making a thermoplastic protein elastomer composite material, the method comprising compounding, at a temperature from about 50° C. and about 180° C., a mixture comprising:
(a) a protein comprising a first functional group, wherein the protein is a protein other than collagen, gelatin, or any combination thereof;
(b) a reactive thermoplastic elastomer comprising a second functional group capable of reacting with the first functional group during compounding; and
(c) a softener.

The present disclosure also provides a method of making a thermoplastic protein elastomer composite material, the method comprising: compounding, at a temperature from about 50° C. to about 180° C., a mixture comprising:
(a) a protein;
(b) a thermoplastic elastomer; and
(c) a softener,
wherein, after compounding, the protein is present within the composite material in a first phase and the thermoplastic elastomer is present within the composite material in a second phase, and wherein the first phase and the second phase are co-continuous.

In some embodiments, the compounding can be performed at a temperature ranging from about 50° C. to about 120° C., about 50° C. to about 150° C., about 50° C. to about 180° C., about 80° C. to about 150° C., about 80° C. to about 125° C., about 80° C. to about 100° C., about 100° C. to about 180° C., about 100° C. to about 150° C., about 100° C. to about 125° C., about 125° C. to about 180° C., about 100° C. to about 150° C., or about 150° C. to about 180° C. In some embodiments, the compounding can be performed at a temperature ranging from about 125° C. to about 150° C. In some embodiments, the compounding can be performed at a temperature of about 140° C.

In some embodiments, the compounding can take place at an agitation rate of from about 20 rpm to about 1000 rpm, about 20 rpm to about 500 rpm, about 20 rpm to about 250 rpm, about 20 rpm to about 200 rpm, about 20 rpm to about 100 rpm, about 100 rpm to about 1000 rpm, about 100 rpm to about 500 rpm, about 100 rpm to about 250 rpm, about 100 rpm to about 200 rpm, about 200 rpm to about 1000 rpm, about 200 rpm to about 500 rpm, about 200 rpm to about 250 rpm, about 250 rpm to about 1000 rpm, about 250 rpm to about 500 rpm, or about 500 rpm to about 1000 rpm. In some embodiments, the compounding can take place at an agitation rate of from about 20 rpm to about 100 rpm.

In some embodiments, the compounding can be performed over a period of from about 1 minute to about 20 minutes, about 1 minute to about 15 minutes, about 1 minute to about 10 minutes, about 1 minute to about 5 minutes, about 5 minutes to about 20 minutes, about 5 minutes to about 15 minutes, about 5 minutes to about 10 minutes, about 10 minutes to about 15 minutes, about 10 minutes to about 20 minutes, or about 15 minutes to about 20 minutes. In some embodiments, the compounding can be performed over a period of about 15 minutes.

In some embodiments, the method can comprise mixing the protein and the softener to form a protein solution, and compounding the protein solution and the reactive thermoplastic elastomer to form the thermoplastic protein elastomer composite material.

In some embodiments, the mixture compounded further comprises a catalyst configured to facilitate the reaction between the second functional group and the first functional group during compounding. In some embodiments, the catalyst can be a base. In some embodiments, the catalyst can be 1,4-diazabicyclo[2.2.2]octane (DABCO), quinuclidine ((1-azabicyclo[2.2.2]octane), DBU (1,8-diazabicyclo[5.4.0]undec-7-ene), DBN (1,5-diazabicyclo[4.3.0]non-5-ene), pyridine, or DMAP (4-dimethylaminopyridine).

In some embodiments, the mixture compounded further comprises a cross-linking reagent configured to form a covalent bond between a protein and a polymer, between two protein molecules, between two polymer molecules, or a combination thereof. In some embodiments, the cross-linking reagent is EDC (1-ethyl-3-(3-dimethylaminopropyl)carbodiimide). In some embodiments, the cross-linking reagent is a compound comprising an aryl azide, a diazirine, an N-hydroxysuccinimide (NHS) ester, an imidoester, a hydrazide, or a combination thereof.

In some embodiments, the method further comprises hot pressing the thermoplastic protein elastomer composite to form a thermoplastic protein composite film.

In some embodiments, the thermoplastic protein elastomer composite can be hot-pressed into a film. In some embodiments, the film can have a thickness ranging of from about 0.5 mm to about 50 mm, including subranges. In some embodiments, the film can have a thickness of about 0.5 mm, about 1 mm, about 2 mm, about 3 mm, about 4 mm, about 5 mm, about 10 mm, about 15 mm, about 20 mm, about 25 mm, about 30 mm, about 35 mm, about 40 mm, about 45 mm, or about 50 mm. In some embodiments, the firm can have a thickness of from about 0.5 mm to about 5 mm, from about 2 mm to about 10 mm, from about 5 mm to about 20 mm, from about 15 mm to about 30 mm, from about 25 mm to about 40 mm, or from about 35 mm to about 50 mm.

In some embodiments, the method further comprises attaching the thermoplastic protein composite to a fabric. In some embodiments, the fabric can be made from one or more natural fibers, for example fibers made from cotton, linen, silk, wool, kenaf, flax, cashmere, angora, bamboo, bast, hemp, soya, seacell, milk or milk proteins, spider silk, chitosan, mycelium, cellulose including bacterial cellulose, or wood. In some embodiments, the fabric can be made from one or more synthetic fibers, for example fibers made from polyesters, nylons, aromatic polyamides, polyolefin fibers such as polyethylene, polypropylene, rayon, lyocell, viscose, antimicrobial yarn (A.M.Y.), Sorbtek, nylon, elastomers such as LYCRA, spandex, or ELASTANE, polyester-polyurethane copolymers, aramids, carbon including carbon fibers and fullerenes, glass, silicon, minerals, metals or metal alloys including those containing iron, steel, lead, gold, silver, platinum, copper, zinc, and titanium, or mixtures thereof.

### Articles Comprising a Thermoplastic Elastomer Composite Material

The present disclosure also provides articles comprising a thermoplastic elastomer composite material described herein. Examples of articles comprising the thermoplastic protein elastomer composite material include, but are not limited to, footwear, garments, gloves, furniture, vehicle upholstery, and other good and products, such as overcoats, coats, jackets, shirts, trousers, pants, shorts, swimwear, undergarments, uniforms, emblems or letters, costumes, ties, skirts, dresses, blouses, leggings, gloves, mittens, shoes, shoe components such as sole, quarter, tongue, cuff, welt, and counter, dress shoes, athletic shoes, running shoes, casual shoes, athletic, running or casual shoe components such as toe cap, toe box, outsole, midsole, upper, laces, eyelets, collar, lining, Achilles notch, heel, and counter, fashion or women's shoes and their shoe components such as upper, outer sole, toe spring, toe box, decoration, vamp, lining, sock, insole, platform, counter, and heel or high heel, boots, sandals, buttons, sandals, hats, masks, headgear, headbands, head wraps, and belts; jewelry such as bracelets, watch bands, and necklaces; gloves, umbrellas, walking sticks, wallets, mobile phone or wearable computer coverings, purses, backpacks, suitcases, handbags, folios, folders, boxes, and other personal objects; athletic, sports, hunting or recreational gear such as harnesses, bridles, reins, bits, leashes, mitts, tennis rackets, golf clubs, polo, hockey, or lacrosse gear, chessboards and game boards, medicine balls, kick balls, baseballs, and other kinds of balls, and toys; book bindings, book covers, picture frames or artwork; furniture and home, office or other interior or exterior furnishings including chairs, sofas, doors, seats, ottomans, room dividers, coasters, mouse pads, desk blotters, or other pads, tables, beds, floor, wall or ceiling coverings, flooring, automobile, boat, aircraft and other vehicular products including seats, headrests, upholstery, paneling, steering wheel, joystick or control coverings and other wraps or coverings.

The embodiments discussed herein will be further clarified in the following examples. It should be understood that these examples are not limiting to the embodiments described above.

### EXAMPLES

### Example 1: Compounding of Gelatin/50 wt % Glycerol and Epoxidized Natural Rubber

150 g of gelatin (gel strength 300, type A, from Sigma-Aldrich) was added to 850 g of deionized water, heated to 50° C. on a hot plate, and mixed with an impeller blade for approximately 30 minutes to solubilize the gelatin. Then 75 g of glycerol was added to the solution and mixed for an additional 5 minutes, which resulted in a gelatin solution with 50 wt % glycerol, based on the weight of glycerol relative to the weight of gelatin. The gelatin solution was then cast at a thickness of less than 2 cm in a wide pan and dried at 45° C. for 2 days. After drying, the cast solution was conditioned at ambient conditions (23° C. and 50% relative humidity) for 1 day.

After conditioning, 25 g of epoxidized natural rubber-50 (ENR-50, 50% of alkene bonds epoxidized) was loaded into a C.W. BRABENDER® ATR PLASTI-CORDER® compounder and compounded at 60 rotations per minute (rpm) and 140° C. for 10 min. Then, 15 g of the conditioned and cast gelatin solution was loaded into the compounder. Immediately after adding the solution, 0.12 g of 1,4-diazabicyclo [2.2.2] octane (DABCO) was loaded into the compounder, the rpm of the compounder was set to 45, and the cast gelatin solution and DABCO were compounded with the ENR-50 for 3 minutes to form a composite compound. During this time, the temperature of the compound was approximately 130° C. The torque in the compounder plateaued at 10 N*m by the end of the three-minute compounding period. This plateau indicated that compounding of the components was successful at the mixing conditions used. The resulting composite compound was scraped out of the compounder and pressed in an Auto Series CARVER® hot press between TEFLON® sheets at 120° C. and 4 tons of pressure for 5 minutes to create a thin, flat puck.

### Example 2: Compounding of SPI/50 wt % Glycerol and Epoxidized Natural Rubber

### Trial A:

170 g of water was warmed on a hot plate to 50° C. and NaOH was added to form a 0.05 N NaOH solution. Then 30 g of soy protein isolate (SPI; SUPRO® XT 221D-IP; DuPont; available from Solae LLC) was added and the solution was mixed with an impeller blade for approximately 30 minutes. After mixing for 30 minutes, 15 g of glycerol was added and the solution was mixed for an additional 5 minutes to create an SPI solution with 50 wt % glycerol, based on the weight of glycerol relative to the weight of SPI. The SPI solution was then cast at a thickness of less than 2 cm in a wide pan and dried at 45° C. for 2 days. After drying, the cast solution was conditioned at ambient conditions (23° C. and 50% relative humidity) for 1 day.

After conditioning, 25 g of ENR-50 was loaded into a C.W. BRABENDER® ATR PLASTI-CORDER® compounder and compounded at 60 rpm and 140° C. for 10 min. Then, 15 grams of the conditioned and cast SPI solution was loaded into the compounder. Immediately after adding the solution, 0.12 g of DABCO was added, the rpm of the compounder was set to 30, and the solution and DABCO were compounded with the ENR-50 for 5 minutes to form a composite compound. During this time, the temperature of the compound was approximately 135° C. The torque in the compounder plateaued at 9 N*m by the end of the five-minute compounding period. The plateau indicated that compounding fully occurred to the extent possible at the conditions used. The resulting compound was scraped out of the compounder and pressed in an Auto Series CARVER® hot press between TEFLON® sheets at 120° C. and 4 tons of pressure for 5 minutes to create a thin, flat puck.

The resultant puck was inhomogeneous, with many visible large dispersed SPI particles in a polymer matrix.

### Trial B

A puck was prepared as described in Trial A above, however the compounding conditions were changed as follows. First, with the ratio of components remaining the same, the total mass of the mixture comprising the SPI solution, DABCO, and ENR-50 was 50 g. Second, the ENR-50 was mixed on its own for 20 minutes to form a melt before being compounded with the SPI solution and DABCO. Third, the ENR-50 melt was allowed to cool to 110° C. before adding the SPI solution, making the mix temperature approximately 115° C. Fourth, the composite compound comprising the SPI solution, DABCO, and ENR-50 was compounded for 10 minutes instead of 5 minutes During the 10 minute compounding period, the torque plateaued at 11 N*m. This plateau indicated that compounding of the components was successful at the conditions used. The resultant puck was more homogeneous than the puck produced in Trial A, but still had many visible dispersed SPI particles.

### Example 3: Compounding and Dyeing of SPI/100 wt % Glycerol with Epoxidized Natural Rubber

An SPI solution was prepared as described in Example 2, using 100 wt % glycerol instead of 50 wt % glycerol. The SPI solution, DABCO, and ENR-50 were mixed to form a compound in same way as described in Example 2, Trial B. The torque in the compounder plateaued at 10 N*m during compounding.

The resultant puck was visually homogeneous. The composite compound of the puck was either a co-continuous phase of SPI and ENR-50, a finely mixed dispersed phase of SPI and ENR-50 comprising small, dispersed SPI particles, or a mixture of the two. The puck was also semi-transparent and dyed homogeneously when dyed using the procedure described below. This puck swelled significantly in water and it appeared that the puck lost mass after swelling in water because the thickness of the puck significantly decreased after drying. This thinning suggested that the SPI within the puck was exposed to water and that, most likely, glycerol (and possibly SPI) leached out from the puck into the water. Since the SPI/glycerol phase morphology was likely co-continuous, the SPI or the glycerol had the potential to leach out of the puck. The puck was, however, still flexible after swelling and drying, although slightly less so than before dyeing.

The puck was dyed using the following procedure. A 1% (w/w) solution of acid dye was made by dissolving 2 g of navy acid dye “3140” (Limonta) in 198 g of DI water. A square puck (63 mm×63 mm and approximately 0.5-1.5 mm thick) was placed in the dye bath and left to react at room temperature (23° C.) for 18 hours on a shaker table at 60 rpm. The puck was then removed from the bath and washed by hand under DI water. After washing, the puck was placed into a bath of pure DI water for another 4 hours at 60 rpm on a shaker table. Finally, the puck was dried for 2 days in a lab fume hood at ambient temperature.

### Example 4: Compounding of Purified Cellulase AC20P/50 wt % Glycerol With Epoxidized Natural Rubber

Cellulase AC20P (Sunson Industry Group Co.) was purified using the following procedure. The cellulase was added to water at a concentration of 25 wt % and mixed until a homogenous solution was formed. The solution was centrifuged using a GEAR HSD-1 Disk stack centrifuge. The feed flow rate was 81 L/h and the ejection timer was set to 180 s. The centrate (light phase) was collected and further purified through ultradiafiltration using a TFF Accela skid with 50 kDa SYNDER® PES spiral wound filters (MQ-2B-3838). The feed flow rate was 220 L/min, the feed pressure was 50 psi, and water was used as the diafilter buffer. Once ultradiafiltration was completed, the resulting retentate solution was concentrated to 25% total solids. The retentate solution was spray dried using a HEMRAJ® Lab 2 Spray Dryer. The aspirator speed was 1500-2000 rpm, the atomization pressure was 1.5 to 2 bar, the inlet temperature was 220° C., and the outlet temperature was 90° C. Once drying was completed, the purified cellulase AC20P was collected as powder from the main drying chamber and used as described below.

60 g of purified cellulase AC20P was added to 340 g of deionized water and mixed with an impeller blade for approximately 30 minutes to solubilize the purified cellulase. Then 30 g of glycerol was added to the solution and mixed for an additional 5 minutes, which resulted in a purified cellulase solution with 50 wt % glycerol, based on the weight of glycerol relative to the weight of purified cellulase. The cellulase solution was then cast at a thickness of less than 2 cm in a wide pan and dried at 45° C. for 2 days. After drying, the cast solution was conditioned at ambient conditions (23° C. and 50% relative humidity) for 1 day.

After conditioning, 25 g of ENR-50 was loaded into a Brabender® ATR Plasti-Corder® compounder and compounded at 30 rpm and 140° C. for 10 min. The ENR-50 was then cooled to 110° C. and 15 g of the conditioned and cast purified cellulase solution was loaded into the compounder. Immediately after adding the solution, 0.12 g of DABCO was loaded into the compounder, the rpm of the compounder was set to 30, and the cellulase solution and DABCO were mixed with the ENR-50 for 5 minutes to form a composite compound. During this time, the temperature of the compound was approximately 135° C. The torque in the compounder plateaued at 9 N*m by the end of the 5 minute compounding period. This plateau indicated that the formed compound was completely compounded to the extent possible at the conditions used. The resulting composite compound was scraped out of the compounder, and pressed in an Auto Series Carver® hot press between Teflon® sheets at 120° C. and 4 tons of pressure for 5 minutes to create a thin, flat puck.

The resulting puck was very inhomogeneous with many large, dispersed cellulase particles. The puck was not dyed.

### Example 5: Compounding of AC20P Cellulase/100 wt % Glycerol With Epoxidized Natural Rubber

An unpurified cellulase solution was prepared as described in Example 4, using 100 wt % glycerol instead of 50% glycerol, and using cellulase AC20P as received with no purification steps. A puck was prepared as described in Example 4 above, however the compounding conditions were changed as follows. First, the mass of ENR-50 used was 31.25 g. Second, the ENR-50 was compounded at 140° C. for 15 min at 60 rpm. Third, 18.75 g of the 100 wt % glycerol unpurified cellulase solution was used. Fourth, mixing was performed at 60 rpm for 10 minutes, at an approximate temperature of 115° C. The torque in the compounder plateaued at 10 N*m by the end of the 10 minute compounding period. This indicated that the formed compound was completely compounded to the extent possible at the conditions used.

The resultant puck was visually homogeneous. The composite compound of the puck was either a co-continuous phase of cellulase and ENR-50, a finely mixed dispersed phase of cellulase and ENR-50 comprising small, dispersed cellulase particles, or a mixture of the two. A minor amount of streaking occurred, potentially attributable to impurities. The puck was also semi-transparent and dyed homogeneously when dyed using the dyeing procedure described above in Example 3. Compared to the puck prepared in Example 4 that had a larger viscosity and a more dispersed phase, the higher glycerol wt % solution appeared to have formed a cellulase solution with a lower viscosity, which may have led towards a more co-continuous or well-compounded puck. The puck swelled somewhat in water but dried with little to no apparent change in material feeling or flexibility.

### Example 6: Compounding of Unpurified AC20P Cellulase Added Directly to Epoxidized Natural Rubber

31.25 g of ENR-50 was compounded at 140° C. for 15 min at 60 rpm in a BRABENDER® ATR PLASTI-CORDER® compounder. The ENR-50 was then allowed to cool to 110° C. at 0 rpm and 18.75 g of cellulase AC20P (unpurified) was added and compounded at 60 rpm for 10 minutes at an approximate temperature of 115° C. The torque in the compounder plateaued at 13 N*m by the end of the 10 minute compounding period. This indicated that that compounding occurred at the conditions used. The resultant composite compound was pressed between TEFLON® sheets at a temperature of 120° C., a force of 4 tons, and for a duration of 5 minutes to form a puck.

The resultant puck was visually homogeneous and more opaque than the pucks of other Examples. The opacity and inability of the cellulase solution to flow on its own (due to its stiffness/viscosity) suggested that the final phase structure had dispersed cellulase particles, but finely dispersed, unlike some of the pucks described in previous examples. The puck dyed homogeneously when dyed using the dyeing procedure described above in Example 3 and was water-stable. The puck swelled less than other cellulase pucks. This swelling behavior was likely due to the dispersed cellulase having less ability to come into contact with water and swell.

### Example 7: Compounding of Uncast Glycerol, AC20P Cellulase and Epoxidized Natural Rubber

9.275 g of AC20P Cellulase powder (without any purification steps), 9.375 g of glycerol (100 wt % of glycerol relative to the weight of cellulase), and 31.25 g of ENR-50 were loaded into a BRABENDER® ATR PLASTI-CORDER® compounder. The loading was performed as follows. The ENR-50 was compounded in the compounder at 150° C. and 60 rpm for 15 minutes. The compounder was then stopped, and the ENR-50 was allowed to cool to 110° C. Then the compounder was restarted at 60 rpm, and the glycerol and cellulase were independently added. The mixture of ENR-50, glycerol, and cellulase was then compounded for 10 minutes at approximately 115° C. During the 10 minute compounding period the torque plateaued at 7.5 N*m. The resultant compound was pressed between TEFLON® sheets with a temperature of 120° C., a force of 4 tons, and for a duration of 5 minutes to form a puck.

The resultant puck was highly inhomogeneous, with large regions of glycerol, which appeared not to be mixed with the cellulase nor the ENR-50. No dyeing or water stability tests were performed on the puck.

Example 8: Compounding of Pea Protein Isolate 870P/50 wt % Glycerol and Epoxidized Natural Rubber

150 g of PURIS® Pea Protein 870 (Ingredion) was added to 850 g of deionized water and mixed with an impeller blade for approximately 30 minutes. Then 75 g of glycerol was added and mixed for an additional 5 minutes to form a pea protein solution with 50 wt % glycerol, based on the weight of glycerol relative to the weight of pea protein. The pea protein solution was then cast at a thickness of less than 2 cm in a wide pan and dried at 45° C. for 2 days. After drying, the cast pea protein solution was conditioned at ambient conditions (23° C. and 50% relative humidity) for 1 day. Upon drying, the pea protein solution was stiff and cracked significantly in the container used for drying, but appeared homogeneous.

25 g of ENR-50 was compounded in a Brabender® ATR Plasti-Corder® compounder at 60 rpm and 140° C. for 10 minutes. 15 g of the cast pea protein solution was loaded into the compounder. Immediately after adding the protein solution, 0.12 g of DABCO was loaded into the compounder and the contents of the compounder were compounded at 30 rpm and an approximate temperature of 135° C. for 5 minutes. The resulting compound was then pressed between Teflon® sheets at 120° C. and 4 tons for 5 minutes to form a puck. The resultant puck was visibly inhomogeneous, with many dispersed areas of pea protein. The puck did, however dye homogeneously when dyed using the dyeing procedure described above in Example 3, likely because the ENR-50 itself is dyeable. The puck was also water stable, with no noticeable change after soaking in a water bath.

### Example 9: Compounding of Zein/50 wt % Glycerol and Epoxidized Natural Rubber

150 g of zein protein powder (Sigma-Aldrich) was added to 850 g of deionized water and mixed with an impeller blade for approximately 30 minutes. Then 75 g of glycerol was added and mixed for an additional 5 minutes, resulting in a zein protein mixture with 50 wt % glycerol, based on the weight of glycerol relative to the weight of zein. The zein protein particles did not dissolve in water but were clearly held in suspension and quickly fell when agitation was stopped. The zein protein mixture was then cast at a thickness of less than 2 cm in a wide pan and dried at 45° C. for 2 days. After drying, the cast zein protein mixture was conditioned at ambient conditions (23° C. and 50% relative humidity) for 1 day. Upon drying, the protein mixture was very friable (weak and easily crumbled) and did not form a homogeneous film. The zein protein particles were still the same size as those in the zein powder originally used to form the protein mixture, and were likely held lightly together by glycerol.

31.25 g of ENR-50 was compounded in a Brabender® ATR Plasti-Corder® compounder at 60 rpm and 140° C. for 15 minutes. The compounder was then stopped and the ENR-50 was allowed to cool to 110° C. Then, 18.75 g of the cast zein protein mixture was loaded into the compounder and the ENR-50 and zein protein mixture were compounded at 60 rpm and approximately 115° C. for 10 minutes to form a composite compound. The torque plateaued at 10 N*m by the end of the 10 minute mixing period. This plateau indicated that the compound was as fully compounded as possible under the conditions used. The compound was then pressed between Teflon® sheets at a temperature of 120° C. and at a force of 4 tons for 5 minutes to form a puck. The resultant puck appeared homogeneous and was relatively opaque, similar to the puck described in Example 6. Similar to Example 6, this the composite compound likely included highly dispersed protein particles.

The puck dyed homogeneously when dyed using the dyeing procedure described above in Example 3. Further, very little swelling in water was noticeable, likely because in a very dispersed state, water cannot reach the zein protein to cause significant swelling. After soaking in water, the final properties of the puck appeared the same as the puck described in Example 6.

### Example 10: Compounding of Egg White Albumin/50 wt % Glycerol and Epoxidized Natural Rubber

30 g of egg white albumin powder (Sigma-Aldrich) was added to 170 g of deionized water and mixed with an impeller blade for approximately 30 minutes to dissolve the egg white albumin powder. Then 15 g of glycerol was added and mixed for an additional 5 minutes, resulting in an albumin protein solution with 50 wt % glycerol, based on the weight of glycerol relative to the weight of albumin. The protein solution was then cast at a thickness of less than 2 cm in a wide pan and dried at 45° C. for 2 days. After drying, the cast protein solution was conditioned at ambient conditions (23° C. and 50% relative humidity) for 1 day. Upon drying, the protein solution was homogeneous and relatively stiff.

A composite compound was prepared as described in Example 9 using the albumin protein solution in place of the zein protein solution. The torque plateaued at 10 N*m during the 10 minute mixing period. The composite compound was then pressed between Teflon® sheets at a temperature of 120° C., and a force of 4 tons for 5 minutes. The resultant puck was highly inhomogeneous with many protein particles, which were found in large, broken pieces with relatively straight edges throughout the polymer. Many of the particles appeared burned from the process. The puck was not dyed.

### Example 10: Complex Viscosity Tests

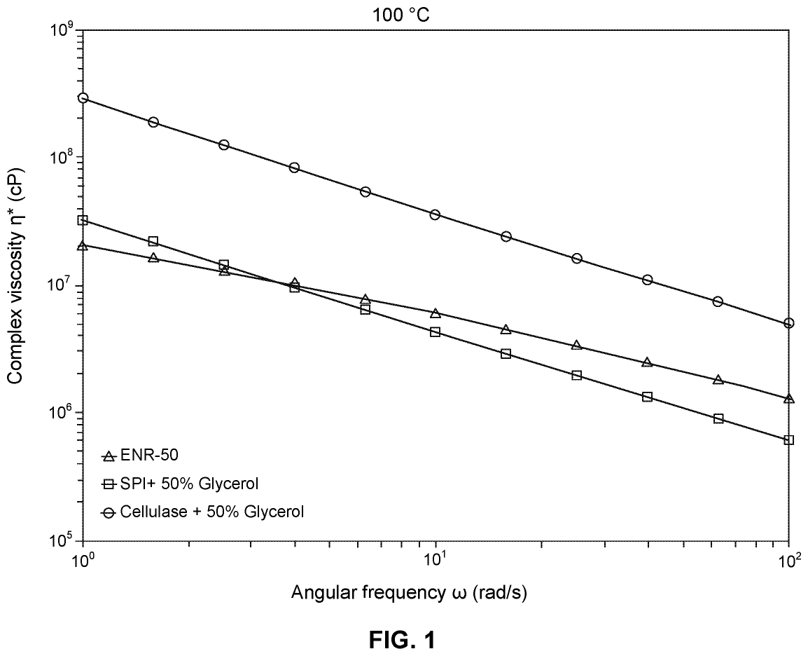

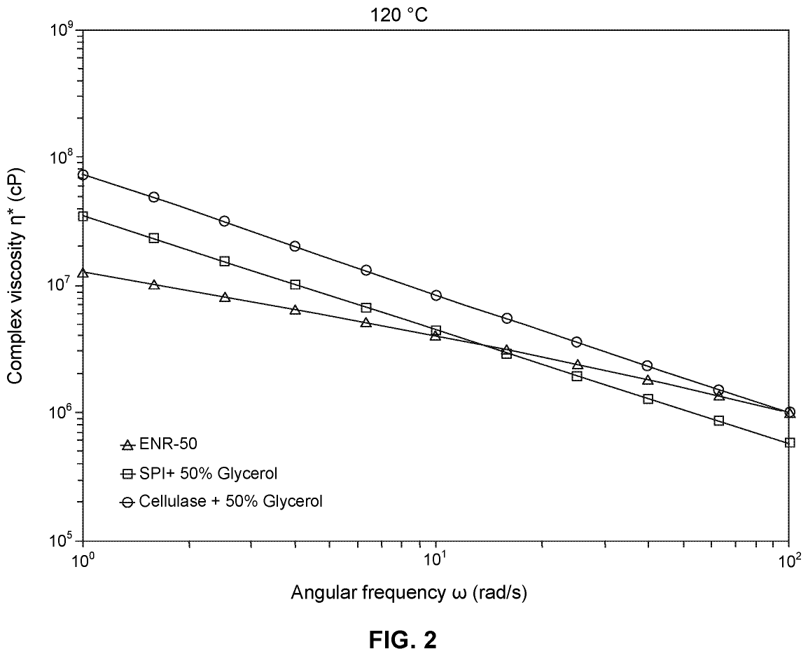

The complex viscosities of three samples were tested at 100° C. and 120° C. The first sample was epoxidized natural rubber-50 (ENR-50, 50% of alkene bonds epoxidized). The second sample was a cast and dried SPI solution prepared according to Example 2 (“SPI+50% Glycerol”). The third sample was a cast and dried cellulase solution prepared according to Example 4 (“Cellulase+50% Glycerol”). FIG. 1 shows the measured complex viscosity of all three samples at 100° C. FIG. 2 shows the measured complex viscosity of all three samples at 120° C.

While various embodiments have been described herein, they have been presented by way of example, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but can be interchanged to meet various situations as would be appreciated by one of skill in the art.

Embodiments of the present disclosure are described in detail herein with reference to embodiments thereof as illustrated in the accompanying drawings, in which like reference numerals are used to indicate identical or functionally similar elements. References to “one embodiment,” “an embodiment,” “some embodiments,” “in certain embodiments,” etc., indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The examples are illustrative, but not limiting, of the present disclosure. Other suitable modifications and adaptations of the variety of conditions and parameters normally encountered in the field, and which would be apparent to those skilled in the art, are within the spirit and scope of the disclosure.

It is to be understood that the phraseology or terminology used herein is for the purpose of description and not of limitation. The breadth and scope of the present disclosure should not be limited by any of the above-described exemplary embodiments, but should be defined in accordance with the following claims and their equivalents.

What is claimed is:

1. A thermoplastic protein elastomer composite material comprising a protein comprising at least one first reactive functional group that has been reacted with a thermoplastic elastomer comprising at least one second reactive functional group
wherein the protein is a protein other than collagen, gelatin, or any combination thereof.

2. The composite material of claim 1, wherein the protein and the thermoplastic elastomer are covalently bound together through reaction of the first and second reactive functional groups.

3. The composite material of claim 1 or 2, wherein the protein is selected from the group consisting of: soy protein, cellulase, zein protein, egg white albumin, and pea protein.

4. The composite material of any one of claims 1-3, wherein the first reactive functional group is an amino group, a hydroxyl group, or a carboxylic acid group.

5. The composite material of any one of claims 1-4, wherein the second reactive functional group is a maleic anhydride, an epoxy group, a silane, or a glycidyl group.

6. The composite material of claim 5, wherein the second reactive functional group is an epoxy group.

7. The composite material of any one of claims 1-6, wherein the thermoplastic elastomer is selected from the group consisting of: a maleated polyethylene, a maleated polypropylene, a maleated styrene-ethylene-butene-styrene block copolymer, a maleated styrene-butadiene-styrene block copolymer, a maleated styrene-ethylene-propylene-styrene block copolymer, a maleated ethylene-propylene rubber, an epoxidized natural rubber, a methyl methacrylate grafted natural rubber, a polyhydroxyalkanoate, and a polyurethane.

8. The composite material of any one of claims 1-6, wherein the thermoplastic elastomer is an epoxidized natural rubber.

9. The composite material of claim 8, wherein the epoxidized natural rubber comprises about 50% epoxidized alkene bonds.

10. The composite material of any one of claims 1-9, wherein the composite material is a film.

11. A method of making a thermoplastic protein elastomer composite material, the method comprising: compounding, at a temperature from about 50° C. to about 180° C., a mixture comprising:
(a) a protein comprising a first functional group, wherein the protein is a protein other than collagen, gelatin, or any combination thereof;
(b) a reactive thermoplastic elastomer comprising a second functional group capable of reacting with the first functional group during compounding; and
(c) a softener.

12. The method of claim 11, wherein the protein is selected from the group consisting of, soy protein, cellulase, zein protein, egg white albumin, and pea protein.

13. The method of claim 11 or 12, wherein the softener is a protein softener.

14. The method of claim 13, wherein the protein softener is an alcohol.

15. The method of claim 14, wherein the alcohol is glycerol.

16. The method of any one of claims 11-15, comprising:
mixing the protein and the softener to form a protein solution, and
compounding the protein solution and the reactive thermoplastic elastomer to form the thermoplastic protein elastomer composite material.

17. The method of any one of claims 11-16, wherein the mixture further comprises a catalyst configured to facilitate the reaction between the second functional group and the first functional group during compounding.

18. The method of any one of claims 11-17, further comprising hot pressing the thermoplastic protein elastomer composite to form a thermoplastic protein composite film.

19. The method of any one of claims 11-18, further comprising attaching the thermoplastic protein composite to a fabric.

20. An article comprising the composite material of any one of claims 1-19.

21. A thermoplastic protein elastomer composite material comprising a protein blended with a thermoplastic elastomer, wherein the protein is present within the composite material in a first phase and the thermoplastic elastomer is present within the composite material in a second phase, and wherein the first phase and the second phase are co-continuous.

22. The composite material of claim 21, wherein about 50% to about 99% of the protein is covalently bound to the thermoplastic elastomer.

23. The composite material of claim 21, wherein about 20% to less than about 50% of the protein is covalently bound to the thermoplastic elastomer.

24. The composite material of claim 21, wherein a detectable amount of the protein to less than about 20% of the protein is covalently bound to the thermoplastic elastomer.

25. The composition material of claim 21, wherein the protein is not covalently bound to the thermoplastic elastomer.

26. The composite material of claim 21, wherein the protein and the thermoplastic elastomer are covalently bound together through reaction of a first functional group on the protein and a second reactive functional group on the thermoplastic elastomer.

27. The composite material of any one of claims 21-26, wherein the protein is a protein other than collagen, gelatin, or any combination thereof.

28. The composite material of any one of claims 21-26, wherein the protein is selected from the group consisting of: soy protein, cellulase, and zein protein.

29. The composite material of any one of claims 21-28, wherein the thermoplastic elastomer is selected from the group consisting of: a maleated polyethylene, a maleated polypropylene, a maleated styrene-ethylene-butene-styrene block copolymer, a maleated styrene-butadiene-styrene block copolymer, a maleated styrene-ethylene-propylene-styrene block copolymer, a maleated ethylene-propylene rubber, an epoxidized natural rubber, a methyl methacrylate grafted natural rubber, a polyhydroxyalkanoate, and a polyurethane.

30. The composite material of any one of claims 21-28, wherein the thermoplastic elastomer is an epoxidized natural rubber.

31. The composite material of claim 30, wherein the epoxidized natural rubber comprises about 50% epoxidized alkene bonds.

32. The composite material of any one of claims 21-31, wherein the composite material is a film.

33. The composite material of any one of claims 21-32, wherein at a temperature between about 50° C. to about 180° C., the first phase has a first complex viscosity at an angular frequency and the second phase has a second complex viscosity at the angular frequency,
further wherein the first complex viscosity is no more than one order of magnitude greater than the second complex viscosity, and
wherein the first complex viscosity is no more than one order of magnitude less than the second complex viscosity.

34. A method of making a thermoplastic protein elastomer composite material, the method comprising: compounding, at a temperature from about 50° C. to about 180° C., a mixture comprising:
(a) a protein;
(b) a thermoplastic elastomer; and
(c) a softener,
wherein, after compounding, the protein is present within the composite material in a first phase and the thermoplastic elastomer is present within the composite material in a second phase, and wherein the first phase and the second phase are co-continuous.

35. The method of claim 34, wherein the protein is a protein other than collagen, gelatin, or any combination thereof.

36. The method of claim 34, wherein the protein is selected from the group consisting of: soy protein, cellulase, and zein protein.

37. The method of claim any one of claims 34-36, wherein the softener is an alcohol.

38. The method of claim 37, wherein the alcohol is glycerol.

39. The method of any one of claims 34-38, further comprising:
mixing the protein and the softener to form a protein solution, and
compounding the protein solution and the thermoplastic elastomer to form the thermoplastic protein elastomer composite material.

40. The method of any one of claims 34-39, further comprising hot pressing the thermoplastic protein elastomer composite to form a thermoplastic protein composite film.

41. The method of any one of claims 34-40, further comprising attaching the thermoplastic protein composite to a fabric.

42. The method of any of claims 34-41, wherein at the temperature between about 50° C. to about 180° C., the first phase has a first complex viscosity at an angular frequency and the second phase has a second complex viscosity at the angular frequency,
further wherein the first complex viscosity is no more than one order of magnitude greater than the second complex viscosity, and
wherein the first complex viscosity is no more than one order of magnitude less than the second complex viscosity.

43. The method of any one of claims 34-42, wherein, after compounding, about 50% to about 99% of the protein is covalently bound to the thermoplastic elastomer.

44. The method of any one of claims 34-42, wherein, after compounding, about 20% to less than about 50% of the protein is covalently bound to the thermoplastic elastomer.

45. The method of any one of claims 34-42, wherein, after compounding, a detectable amount of the protein to less than about 20% of the protein is covalently bound to the thermoplastic elastomer.

46. The method of any one of claims 34-42, wherein, after compounding, the protein is not covalently bound to the thermoplastic elastomer.

47. The method of any one of claims 34-42, wherein, after compounding, the protein and the thermoplastic elastomer are covalently bound together through reaction of a first functional group on the protein and a second reactive functional group on the thermoplastic elastomer.

48. An article comprising the composite material of any one of claims 21-47.

49. The composite material of any one of claims 22-24, wherein the percentage of the protein covalently bound to the thermoplastic elastomer is measured as a mol %.

50. The composite material of any one of claims 22-24, wherein the percentage of the protein covalently bound to the thermoplastic elastomer is measured as a wt %.

51. The method of any one of claims 43-45, wherein the percentage of the protein covalently bound to the thermoplastic elastomer is measured as a mol %.

52. The method of any one of claims 43-45, wherein the percentage of the protein covalently bound to the thermoplastic elastomer is measured as a wt %.
